(19) United States
(12) Patent Application Publication
(10) Pub. No.: US 2012/0210891 A1
(43) Pub. Date: Aug. 23, 2012

(54) PRESSURE ADJUSTMENT DEVICE OF A CHAMBERED DOCTOR BLADE SYSTEM

(75) Inventors: Bernd Kurt Masuch, Kurnach (DE); Wolfgang Otto Reder, Veitshochheim (DE)

(73) Assignee: KOENIG & BAUER AKTIENGESELLSCHAFT, Wurzburg (DE)

(21) Appl. No.: 13/504,603

(22) PCT Filed: Sep. 30, 2010
(86) PCT No.: PCT/EP10/64521

§ 371 Date: Apr. 27, 2012

(30) Foreign Application Priority Data
Oct. 28, 2009 (DE) 102009046078.0

(51) Int. Cl. B41F 31/04

(52) U.S. Cl. 101/350.6

(57) ABSTRACT

A pressure adjustment device of a chambered doctor blade system of a printing press includes at least one chambered doctor blade, at least one ink chamber having at least one supply line connected to an ink reservoir and having at least one drain line or overflow opening that at least partially forms a return flow path of the medium from the at least one ink chamber to the at least one ink reservoir. At least one pressure release valve is arranged in the one of the drain line or overflow opening. Another pressure release valve is also arranged in the at least one supply line. One of the pressure release valves is configured as a passive pressure release valve. The at least one pressure release valve arranged in the at least one supply line has a line connection to at least one bypass line. That bypass line is arranged to at least partially form a return flow path of the medium from the supply line to the ink reservoir.

### CROSS-REFERENCE TO RELATED APPLICATIONS

This application is the U.S. national phase, under 35 USC 371 of PCT/EP2010/064521, filed Sep. 30, 2010; published as WO 2011/051 072 A1 on May 5, 2011 and claiming priority to DE 10 2009 046 078.0, filed Oct. 28, 2009, the disclosures of which are expressly incorporated herein by reference.

### FIELD OF THE INVENTION

The invention relates to a pressure adjustment device of a chambered doctor blade system of a printing press. The chambered doctor blade system has at least one chambered doctor blade and at least one ink chamber that has at least one supply line which is connected to at least one ink reservoir. The at least one ink chamber also has at least one drain line and/or outflow opening which at least partially forms a return flow path for a medium from the at least one ink chamber to the at least one ink reservoir. At least one pressure relief valve is arranged in the at least one drain line and/or outflow opening. At least one pressure relief valve is also arranged in and/or on the at least one supply line.

### BACKGROUND OF THE INVENTION

In printing technology, for example in flexo printing or in waterless offset printing, doctor blades are known, the object of which is to meter the volume of ink applied to a specific surface by wiping off the excess ink. One possible embodiment involves the transfer of ink by way of a roller, for example, a screen roller, which has a plurality of small depressions on its surface, wherein the lands between said depressions are to remain free of ink. In this manner, only a defined volume of ink is supplied to the inking unit connected to the screen roller, and a constant ink intensity is achieved in the printed image.

For this purpose, a chambered doctor blade attached to a doctor blade bar is used, for example, said doctor blade consisting of a sealed off volume, which is delimited by various housing parts and particularly by a part of the screen roller surface and two doctor blades. In this case, the first doctor blade in the direction of rotation is the closing doctor blade, which seals off the volume, and the second doctor blade in the direction of rotation is the working doctor blade, which ensures, by way of its contact with the lands lying between the depressions, that the portion of the ink that is not located inside the depressions will be substantially removed from the surface of the roller.

As a result of said contact, frictional forces are generated on the contact surface between roller and doctor blade, resulting in wear and tear on the surface of the doctor blades at the surface in contact with the screen roller. It is generally undesirable for wear and tear on the material of the roller to be heavier than on the material of the doctor blades, because replacing the roller requires far greater expense. In addition, the shear forces resulting from the viscosity of the ink according to ISO standard 12644:1996(E) further influence wear and tear on the doctor blades. The viscosity of the inks used in waterless offset printing is much higher than the viscosity of inks used in flexo printing. Whereas in flexo printing a viscosity range of ca. 0.05 to 0.5 Pa*s is customary, the viscosity level for inks used in waterless offset printing is ca. 10 to 150 Pa*s. Therefore, in waterless offset printing, higher wear and tear is to be expected.

The pressure inside the chambered doctor blade plays a major role. Depending upon this pressure, a screen roller adjoining the chambered doctor blade can receive too much ink or, in the case of too little pressure, for example, can receive too little ink, and in the case of too much pressure, deformations of a doctor blade bar can also occur, resulting in an unduly wide gap between chambered doctor blade and screen roller, and potentially even resulting in damage, for example, if a doctor blade should become bent as a result of too much pressure.

Moreover, it must be taken into account that in many cases the viscosity of the ink is not constant. Viscosity is dependent upon the temperature of the ink and therefore upon the operating state, and especially upon the temperature of a corresponding printing press. For example, at higher temperatures ink can have a lower viscosity than at lower temperatures. Additionally, thixotropic inks can be used, i.e., inks the viscosity of which decreases over time as long as they are experiencing shear forces, for example as a result of pumping processes, with the viscosity of said inks increasing again over time following a period of rest.

When a low-viscosity ink is pumped into a chambered doctor blade having an outflow opening from which ink is returned to an ink reservoir based upon the law of gravity, the problem can occur that the ink simply runs out to this opening, resulting in an unduly low pressure within the chambered doctor blade and a screen roller that is not uniformly inked.

When a highly viscous ink is pumped into such a chambered doctor blade by a pump that pumps a constant volume per unit of time, even though an appropriate amount of pressure is present due to suitable measures at the opening and at the sites that are relevant to a transfer of ink to the screen roller, due to the high viscosity level and the dramatic drop in pressure inside the associated chambered doctor blade, the pressure inside a supply line and in an area of an inflow opening to the chambered doctor blade can still reach unduly high levels, and therefore, damage can result, or too much ink can be transferred to the screen roller in certain areas.

If an ink that is capable of alternating between a high-viscosity state and a low-viscosity state is used, problems can arise in adjusting the system to the different states of the ink, particularly if a pump having a constant pumping power is used. For this purpose, regulating devices are ordinarily employed, which use appropriate sensors to regulate the pressure inside the chambered doctor blade by way of pumping power, and/or to regulate a regulable valve in a drain line.

Known from DE 102 36 780 C1 is a chambered doctor blade in which an overpressure is generated, and from which liquid medium can be returned, based on the law of gravity, to a reservoir, wherein if necessary, a restricting device for adjusting a flow volume, preferably a manually or automatically controllable valve, can be arranged in a return line. In a preferred embodiment, this valve is connected by circuitry to the machine control system. The pressure in the chambered doctor blade can thus be regulated by measuring the pressure and influencing the flow volume in a return line.

Known from EP 0 461 426 B1 is a device for supplying fluid, which has a chambered doctor blade, wherein the chambered doctor blade forms a closed system along with a reservoir, a pump, and supply and drain lines, wherein in the interior of the chambered doctor blade an overpressure is present, which is regulated by a regulating/flow check valve contained in a bypass line. A pump operates at a constant rate, and a machine control system regulates the pressure in the chambered doctor blade via the regulating/flow check valve connected thereto.

WO 03/091 027 A1 and DE 197 57 094 A1 each disclose a device which is suitable for adjusting the pressure in a chambered doctor blade of a printing press, wherein the chambered doctor blade has at least one ink chamber with at least one supply line connected to an ink reservoir and at least one drain line and/or outflow opening, which returns a medium from the ink chamber to the ink reservoir, and wherein at least one pressure relief valve is arranged in the at least one drain line and/or outflow opening, and wherein at least one pressure relief valve is arranged in at least one supply line, and wherein at least one pressure relief valve is embodied as a passive pressure relief valve.

Known from DE 103 05 918 A1 is a device which is suitable for adjusting the pressure in a chambered doctor blade of a printing press, wherein the chambered doctor blade has at least one ink chamber having at least one supply line connected to an ink reservoir and at least one drain line and/or outflow opening, which returns a medium from the ink chamber to the ink reservoir, and wherein at least one valve is arranged in the at least one drain line and/or outflow opening, and wherein at least one valve is arranged in at least one supply line, wherein the at least one valve in the at least one supply line is arranged in connection with a bypass line, and the bypass line is arranged so as to return the medium to the ink reservoir.

DE 102 25 681 A1 and EP 0 780 228 A1 each describe a device which is suitable for adjusting the pressure in a chambered doctor blade of a printing press, wherein the chambered doctor blade has at least one ink chamber having at least one supply line connected to an ink reservoir and at least one drain line and/or outflow opening which returns a medium from the ink chamber to the ink reservoir, and wherein at least one valve is arranged in the at least one drain line and/or outflow opening, wherein at least one valve in the at least one supply line is arranged in connection with a bypass line, and wherein the bypass line is arranged so as to return the medium to the ink reservoir.

From US 2002/0023587 A1 a device is known which is suitable for adjusting the pressure in a chambered doctor blade of a printing press, wherein the chambered doctor blade has at least one ink chamber having at least one supply line connected to an ink reservoir and at least one drain line and/or outflow opening, which returns a medium from the ink chamber to the ink reservoir, and wherein at least one valve is arranged in the at least one drain line and/or outflow opening.

From U.S. Pat. No. 4,643,124 A an ink supply system of a printing press is known, which has an ink chamber having a supply line connected to an ink reservoir and having a drain line and/or outflow opening that form a return flow path for a medium from the ink chamber to the ink reservoir, and wherein a pressure relief valve is arranged on the supply line and is arranged in a line connection with a bypass line, and the bypass line is arranged so as to at least partially form a return flow path for the medium from the supply line to the ink reservoir.

From DE 10 2007 021 191 A1 a chambered doctor blade system of a printing press is known, which has a drain line and a supply line. The supply line has a segment that leads through a container filled with temperature control medium. A stirring device that thoroughly mixes the temperature control medium is arranged in the temperature control medium container.

### SUMMARY OF THE INVENTION

The problem addressed by the invention is that of providing a pressure adjustment device for a chambered doctor blade system.

The problem is solved according to the invention by the arrangement of the at least one pressure relief valve situated in and/or on the at least one supply line to form a line of connection with at least one bypass line. The at least one bypass line is arranged to at least partially form a return flow path for the medium from the at least one supply line to the at least one ink reservoir.

The advantages to be achieved by the invention consist particularly in that by reliably adjusting the pressure inside the chambered doctor blade, both unduly high and unduly low pressures inside the chambered doctor blade and the lines connected thereto are prevented. This is carried out during various phases or operating states of the corresponding printing press, wherein it is ensured that appropriate pressure conditions are maintained in the case of both high viscosity and low viscosity ink. A transfer of ink to the screen roller is thereby optimized, and pressure-induced damage and/or reductions in quality are prevented or at least substantially diminished. More particularly, by establishing a pressure that lies within a specific range, the service life of doctor blades being used can also be increased substantially, since frictional forces between doctor blade and roller and between doctor blade and viscous ink are influenced by the level of pressure inside the chambered doctor blade.

A further advantage consists in that the means that are used are simple, for example, mechanical in nature, for example, known pressure relief valves. A pressure inside the chambered doctor blade is thereby influenced directly rather than indirectly via at least one intermediate step, for example, a conversion of a measured pressure to a necessary valve position, with a subsequent verification of the resulting pressure. This results in a savings in terms of effort and cost, and makes active, potentially vulnerable control and/or regulating units unnecessary. This is possible due to the fact that pressure relief valves are provided, preferably at least two, one of which establishes an upper pressure limit and one of which establishes a lower pressure limit. Nevertheless, for control purposes or for additional regulating units, a pressure sensor can be used to measure the actual pressure inside the chambered doctor blade, and if necessary, can transmit an appropriate signal for further processing.

A further advantage consists in that the pressure adjustment device uses simple means to ensure a level of pressure inside the chambered doctor blade in different operating states, said pressure level lying within a desired range at all relevant times, particularly throughout an entire printing operation, and independently of a current viscosity of the ink, so that the above-described difficulties or damages are avoided, while equipment costs are kept low.

A further advantage consists in that, by means of a provided bypass line, ink that is pumped out of the ink reservoir in the direction of the ink chamber can be pumped past the ink chamber and back to the ink reservoir, thereby allowing a pump, for example, to operate independently of the currently prevailing pressure and the currently existing viscosity, and at a constant rate or pumping power, and requiring no regulation.

A further advantage consists in that at least one stirring device is arranged in a collecting tank, for example, ensuring less fluctuation in the viscosity of a thixotropic ink, for example, in the case of an interruption in a printing process, in that the ink can be kept in motion by the stirring device.

A further advantage consists in that the at least one valve can be positioned in and/or on a supply line, and that the positioning of the at least one valve can therefore be adapted to flow and/or pressure conditions. For example, positioning said valve on a supply line, particularly in a supply line branch, can keep the flow conditions in the supply line as uniform as possible, whereas positioning said valve directly in the supply line can ensure turbulences that may be desirable, for example, for influencing the viscosity of the ink.

Wear and tear on the doctor blades can be further decreased by applying a wear-resistant coating to the doctor blade, specifically to at least a part of at least one side of the doctor blade, which is either the side of the doctor blade that faces the ink or the side of the doctor blade that is the leading side in the direction of rotation of the adjoining roller, particularly the screen roller, or especially in the case of a chambered doctor blade, is the side of the doctor blade that faces the ink chamber of the chambered doctor blade. This results in less wear and tear than if no coating were provided or if the coating were provided only on the working surface or if the coating were applied only to the side of the doctor blade that faces away from the ink or to the trailing side in the direction of rotation of the adjoining roller, or especially in the case of a chambered doctor blade, to the side of the doctor blade that faces away from the interior of the chamber.

Moreover, applying the wear-resistant coating to the leading side, for example, of the working doctor blade in the direction of rotation of the adjoining roller accounts for the fact that this coating does not always optimally adhere to the material of the doctor blade body. With the described arrangement, the coating is pressed against the material of the doctor blade body by the forces exerted as a result of the rotation of the adjoining roller, whereas when the coating is applied to the trailing surface of the doctor blade in the direction of rotation of the adjoining roller, the active forces pull the coating material away from the doctor blade body and therefore more heavily favor chipping and wear and tear.

By applying the coating exclusively to the side of a doctor blade that faces the ink, said doctor blade forming an acute angle with the trailing portion of a tangent plane on an adjoining roller, in the direction of rotation of said roller, through the line of contact between roller and doctor blade, the advantage results that the surface of the coating requires no additional precision processing during its application, since this surface is no longer in contact solely with the screen roller and therefore is not responsible for a uniform application of ink.

### BRIEF DESCRIPTION OF THE DRAWINGS

One embodiment example of the invention is illustrated in the set of drawings and will be specified in greater detail in what follows.

The drawings show:

FIG. 1 a schematic illustration of a printing couple;

FIG. 2 an enlarged illustration of a section of FIG. 1, showing a chambered doctor blade and a screen roller;

FIG. 3 a perspective illustration of a chambered doctor blade bar including inflow and outflow openings;

FIG. 4 an illustration similar to that of FIG. 2, with a valve in the outflow opening;

FIG. 5 an enlarged illustration of the valve of FIG. 4;

FIG. 6 a valve for opening and/or closing a bypass line;

FIG. 7 an alternative view of the valve of FIG. 6;

FIG. 8 a schematic, perspective illustration of a stirring device in a collecting tank;

FIG. 9 a schematic side view a) and plan view b) of a stirring device in a collecting tank of FIG. 8.

### DESCRIPTION OF THE PREFERRED EMBODIMENT

What is stated above and in the following relates to ink. It should be pointed out, however, that a varnish, for example, or generally some other medium that can be conveyed by means of a pump and/or that has thixotropic properties can be handled using a pressure adjustment device as described. Therefore, all statements are to be understood to mean that printing ink or generally ink also refers to varnish or similar media. It should further be pointed out that what is stated above and in the following refers to pressing, wherein this generally refers to an overpressure relative to a prevailing atmospheric pressure.

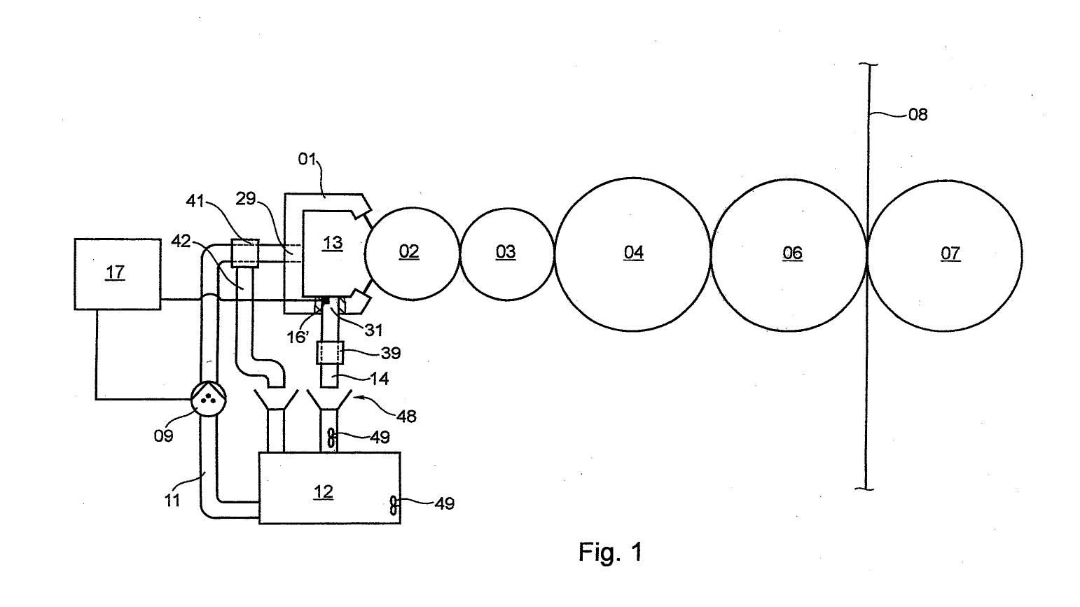

FIG. 1 shows a printing couple of a printing press, particularly of an offset printing press, by way of example, in which a chambered doctor blade 01 can be used. The printing couple shown can be used, for example, for waterless sheet-fed or web-fed offset printing, and has at least one chambered doctor blade 01, which is used to apply ink to an adjoining roller 02, e.g., a screen roller 02, so that the ink will be transferred from there via an additional roller 03, e.g., an ink forme roller 03, to a cylinder 04, e.g., a forme cylinder 04, and then to a cylinder 06, e.g., a transfer cylinder 06. A material 08, in this case a material web 08, e.g., a paper web 08 or a web 08, for example, without restricting the invention thereto, is routed between this transfer cylinder 06 and an additional cylinder 07, which interacts with the transfer cylinder 06 and can be embodied as an impression cylinder 07, so that ultimately the ink is transferred to said web 08. If the printing couple is to be embodied, for example, as a blanket-to-blanket printing couple for imprinting both sides of the web 08, the impression cylinder 07 can be embodied as an additional transfer cylinder 06. To ensure a constant supply of ink, ink is introduced by a plurality of pumps 09 or preferably by one pump 09, for example, ink pump 09, via one or more supply lines 11 from an ink reservoir 12 assigned to the respective pump 09 to an ink chamber 13 of the chambered doctor blade 01. One or more drain lines 14 allow excess ink to be drained out of the ink chamber 13 and returned to the ink reservoir 12. The pump 09 can be embodied as a flexible tube pump 09, for example. Preferably, precisely one pump 09 is provided per supply line 11, however, it is also possible for a plurality of supply lines 11 to be provided, with one pump 09 connected thereto. In one preferred embodiment, a total of two supply lines 11 are arranged at two ends of an ink chamber 13, and one drain line 14 or outflow opening 31 is arranged at the center of the ink chamber 13 between the two supply lines, and one pump 09 is provided for each of the two supply lines 11, interacting with said lines.

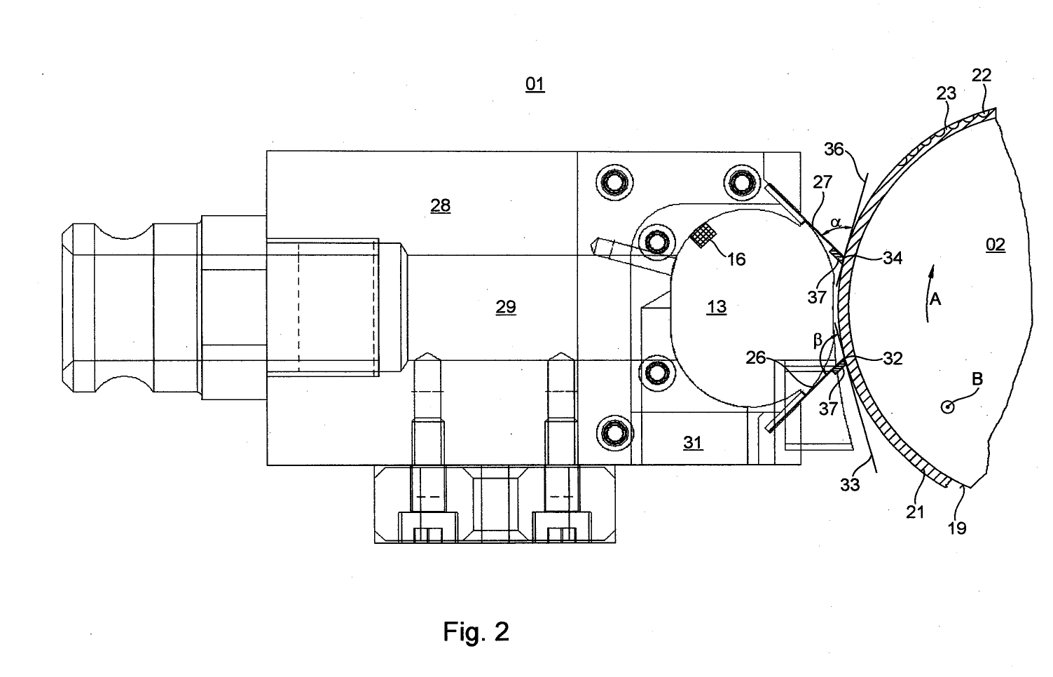

In one embodiment example, a sensor 16; 16′, e.g., a pressure sensor 16; 16′ is provided, which is preferably arranged directly in the ink chamber 13 of the chambered doctor blade 01 (FIG. 2), but can also be integrated into the drain line 14 or drain lines 14 of the chambered doctor blade 01, for example (FIG. 1). The sensor 16; 16′ can also be arranged in a supply line 11. This sensor 16; 16′ monitors the pressure at the location where it is positioned, preferably in order to supply a signal to indicate the pressure within the ink inside the ink chamber 13, and reports the result to a machine control system 17, for example. This machine control system 17 can optionally influence the at least one pump 09, for example, to effect a shut-off in the event of a malfunction, for example. Of course, it is also possible for multiple sensors 16; 16′ to be provided.

The enlarged illustration of the chambered doctor blade 01 shown in FIG. 2 also shows an enlarged illustration of an exemplary screen roller 02, which adjoins said doctor blade during operation. On a surface 19 of the screen roller 02, a coating 21 is applied, which can consist of ceramic, for example, and can have wear-resistant properties. Engraved into this coating 21, preferably by means of laser engraving, are small depressions 22, which have a defined volume and serve to hold ink. The depressions 22 can be cells or tri-helix cells, for example. Between the depressions 22 are lands 23, which are to remain free of ink, with the surfaces thereof being equidistant from the rotational axis of the screen roller 02 in a radial direction. The illustration, particularly of the surface 19, the coating 21, the depressions 22 and the lands 23, is not true to scale.

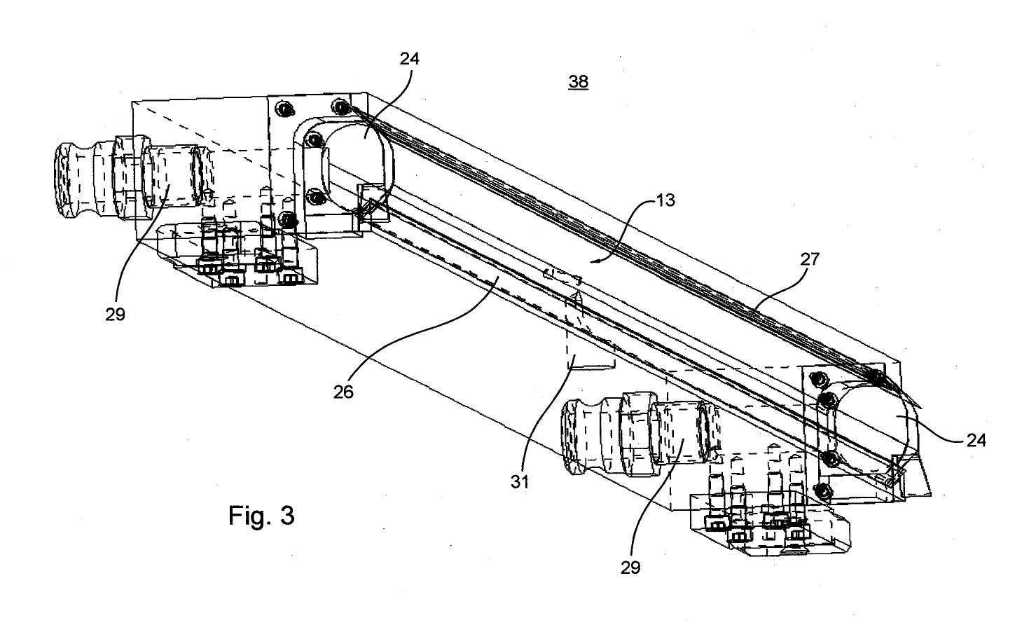

The chambered doctor blade 01 adjoins the screen roller 02. Apart from side plates 24 located at the end faces of the chambered doctor blade 01, which are visible only in FIG. 3, the screen roller 02 is preferably in contact with only two other parts of the chambered doctor blade 01, specifically with a closing doctor blade 26, which is the first doctor blade 26, in other words, the leading doctor blade 26, in the direction of rotation A of the screen roller 02, and a working doctor blade 27, which is the second doctor blade 27, in other words, the trailing doctor blade 27, in the direction of rotation A. In this context, it is pointed out that the direction of rotation A always refers to the direction of rotation of the corresponding screen roller 02 during print operation. The closing doctor blade 26 and the working doctor blade 27 are each connected to a housing 28 of the chambered doctor blade 01. Thus housing 28, closing doctor blade 26, working doctor blade 27 and the corresponding segment of the screen roller 02, along with the side plates 24, together form a sealed volume in the interior of the chambered doctor blade 01, specifically the above-mentioned ink chamber 13. This ink chamber 13 has only one or more inflow openings 29 and one or more outflow openings 31, which serve to supply and/or drain ink into and/or out of the ink chamber 13.

The part of a tangent plane 33 on the screen roller 02 that points from a line of contact 32 between closing doctor blade 26 and screen roller 02 in the direction of rotation A forms an obtuse angle β with the closing doctor blade 26. The angle β is preferably greater than 120° and less than 165°. The part of a tangent plane 36 on the screen roller 02 that points from a line of contact 34 between working doctor blade 27 and screen roller 02 in the direction of rotation A forms an acute angle α with the working doctor blade 27. The angle α is preferably greater than 15° and less than 60°.

In the illustrated example of the working doctor blade 27, a possible coating 37 is located exclusively on the leading side of the working doctor blade 27, viewed in the direction of rotation A of the adjoining screen roller 02, in other words, on the side of the working doctor blade 27 that faces the ink and the ink chamber 13, and in the case of the closing doctor blade 26, said coating is located exclusively on the leading side of the closing doctor blade 26, viewed in the direction of rotation A of the adjoining screen roller 02, in other words, on the side of the closing doctor blade 26 that faces away from the ink and the ink chamber 13.

This preferred example with respect to the coating 37 is not intended as a restriction, since it is possible for the coating 37 to be located on one of the two sides or on both sides of the closing doctor blade 26, and it is also possible, independently thereof, for the coating 37 to be located on one of the two sides or on both sides of the working doctor blade 27. It is also possible for the coating 37 to be located only on the closing doctor blade 26 or only on the working doctor blade 27, and in both of these cases the coating 37 can be applied to one or to both sides of the closing doctor blade 26 or the working doctor blade 27.

For the closing doctor blade 26 and the working doctor blade 27, each of which is preferably embodied as a narrow metal band, the following orientations and dimensions are specified: The length is the dimension in the direction B parallel to the axis of rotation of the adjoining screen roller 02. The width in each case is the largest dimension orthogonally to the length of the closing doctor blade 26 and/or the working doctor blade 27. The height is the extension in the direction orthogonally to the length and the width.

The coating 37 extends in the direction parallel to the axis of rotation B of the adjoining screen roller 02, at least over a part, but preferably over the entire length of the closing doctor blade 26 and/or the working doctor blade 27. The width of the coating 37, in other words, the extension of the coating 37 on the surface of the closing doctor blade 26 and/or the working doctor blade 27 along the direction of the width of the closing doctor blade 26 and/or of the working doctor blade 27, is 1 mm to 8 mm, but preferably 4 mm to 6 mm. The thickness of the coating 37, in other words, the extension of the coating 37 in the direction of the height of the closing doctor blade 26 and/or of the working doctor blade 27, is 10 μm to 300 μm, but preferably 150 μm to 250 μm. The material of the coating 37 is a ceramic, for example, which is applied by a spraying method, for example. It can consist of a mixture of Al₂O₃ (aluminum oxide), ZrO₂ (zirconium dioxide) and TiO₂ (titanium dioxide), for example, wherein Al₂O₃ serves as the base material and ZrO₂ is preferably present in a mass percentage of 20-50%, and TiO₂ in a mass percentage of 0-20% of the total mass. In another embodiment, the ceramic coating consists of 90-99%, but preferably 97%, Al₂O₃, with the remaining mass percentage consisting of TiO₂.

FIG. 3 shows a perspective view of the entire doctor blade bar 38, which supports all important elements of the chambered doctor blade 01. In the interest of clarity, only the side plates 24 for sealing the ink chamber 13, the two inflow openings 29 in this example, the one outflow opening 31 in this example, and the working doctor blade 27 and the closing doctor blade 26 are identified.

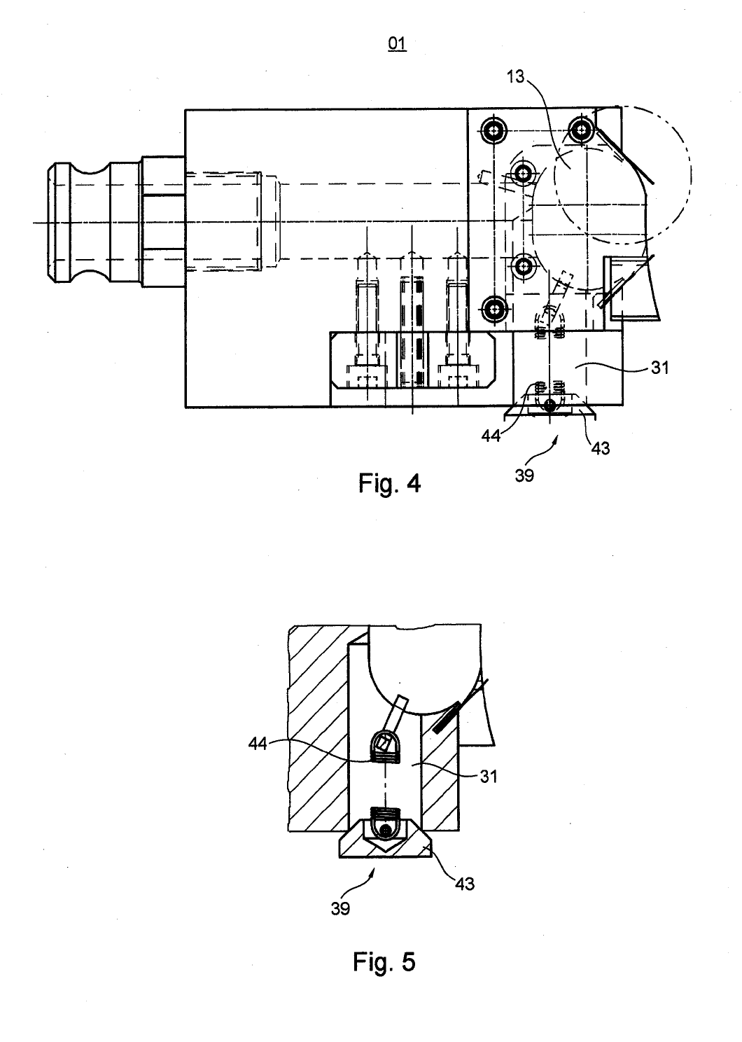

In at least one drain line 14 and/or outflow opening 31, at least one valve 39 is arranged (FIGS. 4 and 5), which is embodied as a pressure relief valve 39 and preferably as a passive pressure relief valve 39, which opens automatically under excess pressure and has only mechanical components, which preferably are not actively controlled or regulated. In this context, active control or regulation is understood as an intervention into the control or regulation process by an operator and/or an electrical circuit. No sensor is connected by circuitry to a passive pressure relief valve 39; 41. More particularly, a passive pressure relief valve 39; 41 has no lines for transporting anything other than the medium to be transported, particularly ink. This means that only lines that conduct or can conduct the medium itself, for example, the ink, are connected to the passive pressure relief valve 39; 41. No additional pneumatic lines, hydraulic lines or electrical lines are connected to the passive pressure relief valve 39; 41. More particularly, the passive pressure relief valve 39; 41 is not connected to an electrical circuit. In the case of multiple drain lines 14 and/or outflow openings 31, multiple valves 39 can preferably also be provided, in order to ensure a uniform effect. FIG. 4 shows a section similar to that of FIG. 2, but with fewer details and with an identified valve 39. This at least one valve 39 opens the corresponding drain line 14 and/or outflow opening 31 only when a certain minimum pressure, which preferably ranges from 10 kPa to 50 kPa and more preferably ranges from 15 kPa to 20 kPa, is present on the side of the valve 39 that faces the ink chamber 13.

The drain lines 14 can also be embodied as lines that are open toward the bottom, so that a return of ink at least downstream of the preferred valves 39 is induced solely by gravitational force according to the law of gravity, and a closed system is not formed. It is also possible to provide a sealable supplemental line between ink chamber 13 and ink reservoir 12, parallel to a drain line 14 that contains a valve 39, for the gravity-induced emptying of the ink chamber 13, for example. Such a supplemental line is not shown in the figures.

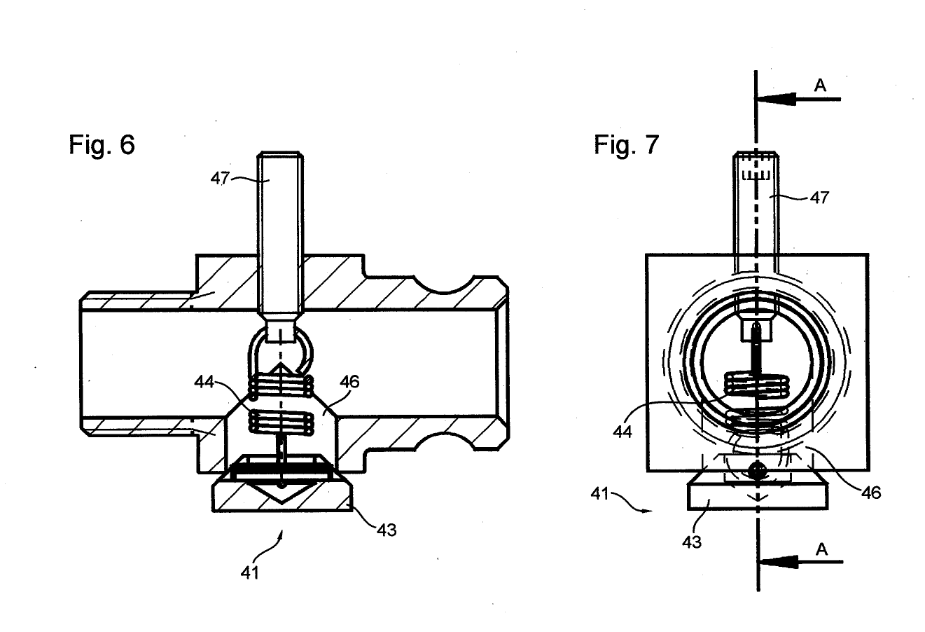

At least one valve 41, which is embodied as a pressure relief valve 41 and preferably as a passive pressure relief valve 41, is also arranged in or on at least one supply line 11 (FIGS. 6 and 7). This at least one valve 41 seals or opens an outlet opening 46, and thereby preferably a bypass line 42. If the pressure in the supply line 11 and/or in the inflow opening 29 to the ink chamber 13 becomes too great but the pump 09 nevertheless continues to pump ink toward the ink chamber 13, the excess portion of the ink can be diverted through the opening of the outlet opening 46 and/or the bypass line 42, preferably back to the ink reservoir 12, also preferably induced solely by gravity, at least after the ink passes the at least one valve 41. A maximum pressure, beyond which the at least one valve 41 is opened, preferably ranges from 60 kPa to 160 kPa, and further preferably ranges from 60 kPa to 80 kPa. The maximum pressure at which the at least one valve 41 opens is preferably higher than the minimum pressure at which valve 39 opens. A supply line branch is understood as a piece of line which branches off from a supply line 11, for example, by means of a T-connector. Regardless of whether the at least one valve 41 is arranged in a supply line 11 or in a supply line branch, it forms a control device by means of which a diversion of ink around the ink chamber 13 is controlled. An arrangement of a valve 41 in a supply line 11 is understood as an arrangement in which at least one component of the valve 41 intersects the shortest flow path through the supply line 11. An arrangement of a valve 41 on a supply line 11 is understood as an arrangement in which at least one component of the valve 41 does not intersect the shortest possible flow path through the supply line 11, and is instead arranged in a supply line branch, for example, particularly in the bypass line 42. For determining the shortest flow path, in this case, all lines are considered to be unidimensional, in other words, linear.

Both the at least one valve 39 and the at least one valve 41 are preferably embodied as passive valves 39; 41, which remain closed up to a respective pressure, and beyond this respective pressure are opened. One possibility for a particularly simple configuration of such a valve 39; 41 consists in sealing an opening with a cover 43 by forcing said cover against the opening by means of a spring 44. This spring 44 can act both as a compression spring 44, pressing the cover 43 from the side having the lower pressure toward the side having the higher pressure, and as a helical tension spring 44, pulling the cover 43 away from the side having the higher pressure toward the opening of the line. In the case of valve 39, this preferably seals off a volume, preventing ink from exiting, whereas in the case of valve 41, this seals off a branch in a line, only optionally opening up another possible path for transported ink. The cover 43 and/or the opening that interacts with it preferably have sealing means, for example, a rubber ring, to ensure a tight seal.

The pressure ranges at which the valves 39; 41 open are naturally entirely dependent upon the ink that is used and the embodiment of the chambered doctor blade 01, however, with the stated pressure ranges, particularly satisfactory printing results could be achieved. For example, with the same pumping power of the pump 09 and a high-viscosity ink, pressures of 70 kPa could be achieved at the outflow opening 31 without a valve 41, and with a valve 41, pressures of 30 to 40 kPa could be achieved. At the inflow opening 29, pressures of 150 kPa without valve 41 and of 70 kPa with valve 41 are possible.

The valves 39; 41 preferably have means 47 for adjusting the pressure at which a corresponding valve 39; 41 will open. The minimum pressure and the maximum pressure in the ink chamber 13 can therefore be adjusted manually and/or via the machine control system 17, and thereafter they require no further monitoring. FIG. 6 and FIG. 7 show such a means 47, which can be a screw 47, for example. In this case, by displacing the means 47, the initial tension of the spring 44 can be influenced. A greater initial tension of the spring 44 means that the cover 43 is pressed with greater force against the opening, and therefore, a greater force, in other words, greater pressure, is also necessary for opening the valve 39; 41.

By means of the valves 39; 41, at least during operation of the pump 09, a pressure is maintained in the ink chamber 13 that lies between a preferably adjustable minimum pressure and a preferably adjustable maximum pressure. This occurs as follows:

In one operating state, in which low-viscosity ink is pumped by the pump 09 through the supply line 11, after a certain time the chambered doctor blade 01 should be filled with ink. The at least one valve 39 ensures that the low-viscosity ink becomes dammed up in the ink chamber 13 and that a certain minimum pressure builds up. Only when this minimum pressure is reached does the valve 39 open and allow ink to escape via a path other than via the screen roller 02. The pump 09 continues to pump ink at a constant output into the ink chamber 13, so that the pressure can be maintained. If, for whatever reason, the pressure should drop too low, the valve 39 will close on its own, preventing a further drop in pressure. In this operating state, the valve 41 has no influence under normal circumstances, since it opens only after a higher pressure is reached.

In an operating state in which high-viscosity ink is pumped by the pump 09 through the supply line 11, the chambered doctor blade 01 should also be filled with ink after a certain time. The pressure inside the chambered doctor blade 01 increases, and as soon as the minimum pressure is reached the valve 39 opens. However, the highly viscous properties of the ink result in a dramatic drop in pressure in the ink between the inflow opening 29 and the outflow opening 31, for example. To achieve the minimum pressure at the valve 39, therefore, a very high pressure of 150 kPa or even more, for example, can develop in the area of the inflow opening 29. In order to avoid negative consequences, the valve 41 opens at a maximum pressure of preferably 60 kPa to 80 kPa, ensuring a reduction in the pressure prevailing there. A diversion of all the ink, which would result in no additional ink being supplied to the ink chamber 13, is avoided, because when the pressure drops too low, the valve 41 closes again and all the ink is supplied to the ink chamber 13.

In one preferred embodiment, in areas that are located downstream of the outflow opening 31 and upstream of the pump 09, for example in a collecting tank 48, or also generally in areas in which otherwise low shear forces prevail within the ink, at least one stirring device 49 is arranged (FIGS. 1, 8, 9a and 9b). This stirring device 49 serves, for example, to keep a thixotropic ink in motion, thereby keeping its viscosity low, for example, in the event of an interruption in a printing process or also during preparation for a printing process. This facilitates the pumping work of the pump 09, for example, and ensures less dramatic fluctuations in the viscosity of the ink. The reduced fluctuations in viscosity further intensify the corrective effect of the interacting valves 39; 41. It is not necessarily a function of the stirring device 49 to participate in the actual process of transporting the ink; instead, the stirring device 49 serves to bring the ink to an advantageous state, particularly with respect to its viscosity, and/or to keep it in this state. The stirring device 49 is preferably arranged in such a way that no air bubbles are stirred into the ink, for example, the stirring device 49 or at least relevant components of the stirring device 49 can be arranged entirely below the surface of the ink, in other words, within the ink. Relevant components of the stirring device 49 are particularly those components of the stirring device that are in contact with and/or come into contact with the ink.

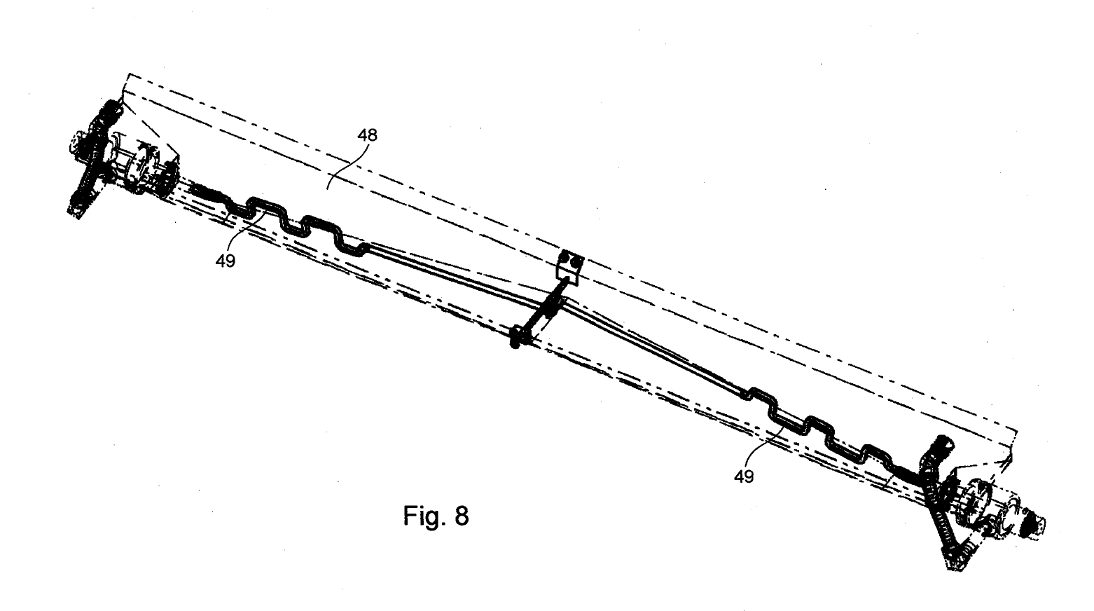

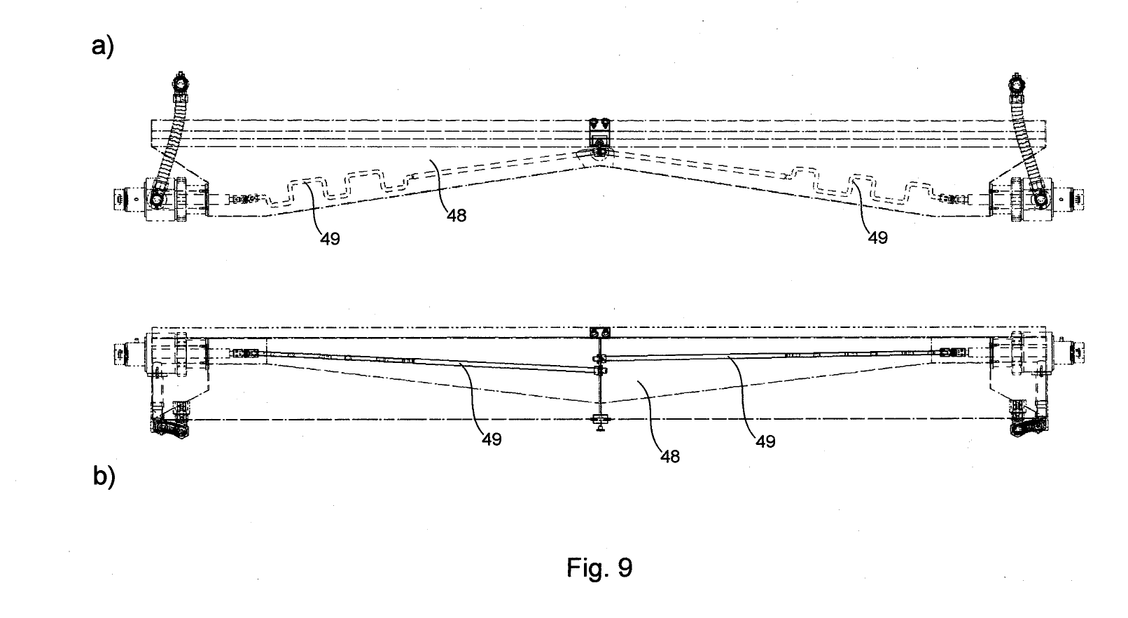

One embodiment of a stirring device 49, which is also illustrated in FIGS. 8, 9a and 9b, is a rod which is capable of rotating about its longitudinal axis and which has at least one curve, and, to avoid imbalances, has at least two curves. A curve is understood as a part of the rod that disrupts the rotational symmetry of the rod. However, other embodiments are also possible, for example, spiral, helical, propeller-like, etc.

A chambered doctor blade system preferably has at least one chambered doctor blade 01, at least one ink chamber 13, at least one ink reservoir 12, at least one pump 09, at least one supply line 11, and at least one drain line 14 and/or at least one outflow opening 31. Preferably, the chambered doctor blade system has at least one bypass line 42 and at least two valves 39; 41.

A return flow path is preferably an arrangement of lines and/or surfaces and/or drop distances, along which ink or a general medium can be returned from a specific point to the ink reservoir 12. From the at least one supply line 11, at least one possible return flow path leads through the at least one ink chamber 13, the at least one valve 39, and the at least one drain line 14 and/or outflow opening 31, and at least one other return flow path leads through the at least one valve 41 and the at least one bypass line 42. The bypass line 42 can also be very short, and can particularly consist of only one opening 42, which in cases of doubt is opened by the corresponding valve 41, opening up the path from the supply line into the open and ultimately back to the ink reservoir 12.

While a preferred embodiment of a pressure adjustment device of a chambered doctor blade system in accordance with the present invention has been set forth fully and completely hereinabove, it will be apparent to one of skill in the art that various changes could be made without departing from the true spirit and scope of the present invention which is accordingly to be limited only by the appended claims.

What is claimed is:

1-21. (canceled)

22. A pressure adjustment device of a chambered doctor blade system of a printing press, wherein the chambered doctor blade system has at least one chambered doctor blade (01) and at least one ink chamber (13) having at least one supply line (11), connected to at least one ink reservoir (12), and having at least one drain line (14) and/or outflow opening (31), which at least partially forms a return flow path for a medium from the at least one ink chamber (13) to the at least one ink reservoir (12), and wherein at least one pressure relief valve (39) is arranged in the at least one drain line (14) and/or outflow opening (31) and wherein at least one pressure relief valve (41) is arranged in and/or on at least one supply line (11), characterized in that the at least one pressure relief valve (41) arranged in and/or on the at least one supply line (11) is arranged so as to form a line connection with at least one bypass line (42), and in that the at least one bypass line (42) is arranged so as to at least partially form a return flow path for the medium from the at least one supply line (11) to the at least one ink reservoir (12).

23. The pressure adjustment device according to claim 22, characterized in that the at least one pressure relief valve (39) arranged in the at least one drain line (14) and/or outflow opening (31) and the at least one pressure relief valve (41) arranged in and/or on the at least one supply line (11) are each embodied as passive pressure relief valves (39; 41), which open automatically under unduly high pressure and have only mechanical components.

24. The pressure adjustment device according to claim 22, characterized in that the at least one pressure relief valve (39) arranged in the at least one drain line (14) and/or outflow opening (31) is embodied as a pressure relief valve (39) that opens at a minimum pressure, and in that the at least one pressure relief valve (41) arranged in and/or on the at least one supply line (11) is embodied as a pressure relief valve (41) that opens at a maximum pressure, and in that the minimum pressure is lower than the maximum pressure.

25. The pressure adjustment device according to claim 22, characterized in that precisely one pump (09) is provided per supply line (11).

26. The pressure adjustment device according to claim 22, characterized in that at least one stirring device (49) which keeps the medium in motion is provided or can be provided.

27. The pressure adjustment device according to claim 26, characterized in that the at least one stirring device (49) is arranged in the at least one ink reservoir (12) and/or in at least one collecting tank (48).

28. The pressure adjustment device according to claim 22, characterized in that the at least one pressure relief valve (39) arranged in the at least one drain line (14) and/or outflow opening (31) is embodied to open at an overpressure ranging from 10 kPa to 50 kPa.

29. The pressure adjustment device according to claim 22, characterized in that the at least one pressure relief valve (39) arranged in the at least one drain line (14) and/or outflow opening (31) is embodied to open at an overpressure ranging from 15 kPa to 20 kPa.

30. The pressure adjustment device according to claim 22, characterized in that the at least one pressure relief valve (41) arranged in and/or on the at least one supply line (11) is embodied to open at an overpressure ranging from 60 kPa to 160 kPa.

31. The pressure adjustment device according to claim 22, characterized in that the at least one pressure relief valve (41) arranged in and/or on the at least one supply line (11) is embodied to open at an overpressure ranging from 60 kPa to 80 kPa.

32. The pressure adjustment device according to claim 22, characterized in that at least one pressure relief valve (39; 41) has at least one cover (43) and at least one spring (44).

33. The pressure adjustment device according to claim 32, characterized in that the spring (44) is embodied as a helical tension spring (44) or as a compression spring (44) and is arranged so as to interact with the cover (43).

34. The pressure adjustment device according to claim 22, characterized in that the at least one pressure relief valve (41) arranged in and/or on the at least one supply line (11) is arranged directly in the at least one supply line (11).

35. The pressure adjustment device according to claim 22, characterized in that the at least one pressure relief valve (41) arranged in and/or on the at least one supply line (11) is arranged on the at least one supply line (11), in other words, in a supply line branch.

36. The pressure adjustment device according to claim 22, characterized in that the at least one bypass line (42) is arranged so as to at least partially form the return flow path for the medium from the at least one supply line (11) to the at least one ink reservoir (12), circumventing the at least one ink chamber (13).

37. The pressure adjustment device according to claim 22, characterized in that the chambered doctor blade system has precisely one pump (09).

38. The pressure adjustment device according to claim 23, characterized in that the mechanical components are not actively controlled or regulated.

39. The pressure adjustment device according to claim 23, characterized in that no sensor is connected by circuitry to the passive pressure relief valves (39; 41).

40. The pressure adjustment device according to claim 23, characterized in that only those lines that conduct or are capable of conducting the medium are connected to the passive pressure relief valves (39; 41).

41. The pressure adjustment device according to claim 23, characterized in that the passive pressure relief valves (39; 41) are not connected to an electrical circuit.

42. The pressure adjustment device according to claim 23, characterized in that no pneumatic lines, hydraulic lines or electrical lines are connected to the passive pressure relief valves (39; 41).
